(19) United States
(12) Patent Application Publication
(10) Pub. No.: US 2019/0120075 A1
(43) Pub. Date: Apr. 25, 2019

(54) NEAR NET SHAPE ABRADABLE SEAL MANUFACTURING METHOD

(71) Applicant: United Technologies Corporation, Farmington, CT (US)

(72) Inventor: Christopher W. Strock, Kennebunk, ME (US)

(73) Assignee: United Technologies Corporation, Farmington, CT (US)

(21) Appl. No.: 16/218,949

(22) Filed: Dec. 13, 2018

Related U.S. Application Data
(63) Continuation-in-part of application No. 14/708,518, filed on May 11, 2015.

(51) Int. Cl. F01D 11/12; B22F 3/10; F01D 5/28

(52) U.S. Cl. CPC F01D 11/122; B22F 3/1017; F01D 5/282; F01D 5/288; F05D 2230/31; F05D 2300/615; F05D 2300/121; F05D 2300/17; F05D 2300/2282; F05D 2300/6032; F05D 2300/609; F05D 2240/55

(57) ABSTRACT

A method of manufacturing a net shaped seal comprising depositing a first layer of powder material on a substrate; the powder material comprising an abradable feedstock material comprising matrix alloy clad filler particles, wherein the matrix alloy cladding includes Al, Cu, Ni, Co, Cr, Fe, Si and Y; guiding a heat source over the powder material layer; laser sintering the powder material, the matrix alloy clad filler particles sinter in the absence of the filler particles melting; depositing a second layer of powder material over the first layer; laser sintering the second layer of powder material with a second laser pass at predetermined locations; wherein at least one of the matrix alloy clad filler particles sinter, and in the absence of the filler particles melting; and repeating the depositing step and laser sintering step to form subsequent layers to form an abradable seal on the substrate.

### CROSS-REFERENCE TO RELATED APPLICATION

This application is a Continuation-In-Part of U.S. patent application Ser. No. 14/708,518, filed May 11, 2015.

### BACKGROUND

The disclosure relates to a method and material feedstock to produce the next generation compressor abradable seals with high raw material utilization ratio and reduced process steps.

In compressor and turbine sections of a gas turbine engine, air seals are used to seal the interface between rotating structure, such as a hub or a blade, and fixed structure, such as a housing or a stator. For example, typically, circumferentially arranged blade seal segments are fastened to a housing, for example, to provide the seal.

Relatively rotating components of a gas turbine engine are not perfectly cylindrical or coaxial with one another during engine operation. As a result, the relatively rotating components may occasionally rub against one another. To this end, an abradable material typically is adhered to the blade seal segments or full rings and/or the rotating component.

Abradable seals in the compressor section of gas turbine engines include characteristics such as, good abradability, spall resistance, and erosion resistance. Abradable seals are required to exhibit a smooth surface, low gas permeability, and environmental durability. The seal is a sacrificial element in order to minimize blade wear, so it is abradable. The seal must also minimize gas flow leakage through the seal, so a low gas permeability is desirable.

Conventional abradable liners are typically thermally sprayed (e.g., plasma sprayed) metal coatings for compressors, and thermally sprayed ceramic coatings for turbines. These coatings have to provide a balance in mechanical properties between a requirement to be soft enough to be abraded and hard enough to resist erosion. Thus thermally sprayed abradable coatings generally have a metallic matrix (e.g., based on Ni, Cr or Al) and an abrasive phase to impart improved cutting characteristics

The thermal spray deposition methods produce overspray of the coating material. The thermal spray deposition often requires substantial part masking and post spray machining to produce a finished part. These state of the art abradable materials are costly at over $100/lb. and are deposited with a finished part to powder used ratio estimated at less than 20%. This is very wasteful of not only the powder material, but also manpower and lead time.

There is a need to develop a manufacturing process that deposits abradable coatings with a higher powder utilization efficiency and reduced number of manufacturing operations. The new process should manufacture a coating via the initial production of the part very close to the final net shape, or near net shape, thus reducing the need for surface finishing, such as grinding, machining and the like.

### SUMMARY

In accordance with the present disclosure, there is provided a method of manufacturing a net shaped seal comprising depositing a first layer of powder material on a substrate; said powder material comprising an abradable feedstock material comprising matrix alloy clad filler particles, wherein said matrix alloy cladding is selected from the group consisting of Al, Cu, Ni, Co, Cr, Fe, Si and Y; guiding a heat source over said powder material layer; laser sintering said powder material, wherein at least one of said matrix alloy clad filler particles sinter, and in the absence of said filler particles melting; depositing a second layer of powder material over said first layer; laser sintering said second layer of powder material with a second laser pass at predetermined locations; wherein at least one of said matrix alloy clad filler particles sinter, and in the absence of said filler particles melting; and repeating the depositing step and laser sintering step to form subsequent layers to form an abradable seal on said substrate.

In another alternative embodiment the method includes the abradable seal being discontinuously filled with at least one of a hexagonal boron nitride, MAX phase material and a hexagonal boron nitride agglomerate.

In another alternative embodiment the abradable seal comprises additional metal matrix particles.

In another alternative embodiment the abradable seal is discontinuously filled with at least one of fugitive pore formers, glass micro-balloons, ceramic micro-balloons and a soft phase material.

In another alternative embodiment the abradable feedstock material comprises a MAX phase filler material.

In another alternative embodiment the feedstock is a composite powder comprising at least one of additional metal matrix particles, fugitive pore formers, glass micro-balloons, ceramic micro-balloons and a soft phase material.

In another alternative embodiment the abradable feedstock material comprises a MAX phase filler material.

In another alternative embodiment the method includes cladding said matrix alloy onto said filler particles, by at least one of chemically cladding, mechanically cladding and adhesively cladding.

In accordance with the present disclosure, there is provided a method of manufacturing a net shaped seal that comprises depositing a first layer of powder comprising an abradable feedstock material on a substrate wherein the abradable feedstock material comprises a matrix alloy consisting of Al, Cu, Ni, Co, Cr, Fe, Si, Y and the abradable feedstock material comprises a filler comprising metal clad hBN particles. The method includes guiding a heat source over the powder material layer; sintering the powder material, wherein at least one of the matrix alloy particles and the matrix layer of the clad filler particles adheres to adjacent particles by solid state sintering or partial melting and in the absence of the filler material melting; depositing a second layer of powder material over the first layer; sintering the second layer of powder material with a second pass of the heat source at predetermined locations wherein at least one of the matrix alloy particles and the matrix layer of the clad filler particles adheres to adjacent particles by solid state sintering or partial melting and in the absence of the filler material melting; and repeating the depositing step and sintering step to form subsequent layers to form an abradable seal on the substrate. Exemplary heat source being a laser beam.

In another alternative embodiment the method includes applying a bond coat to the substrate prior to applying the first layer.

In another and alternative embodiment, the abradable feedstock material comprises a matrix alloy selected from the group consisting of Al, Cu, Ni, Co, Cr, Fe, Si, Y and a filler comprising at least one of hBN, MAX phases and bentonite.

In another and alternative embodiment, the matrix is discontinuously filled with at least one of a hexagonal boron nitride and a hexagonal boron nitride agglomerate.

In another and alternative embodiment, the matrix is discontinuously filled with a soft phase material and/or discontinuously filled with at least one of additional metal matrix particles, fugitive pore formers, glass micro-balloons, ceramic micro-balloons and a soft phase material in a composite powder.

In another and alternative embodiment, the abradable feedstock material comprises a MAX phase filler material.

Further in accordance with the present disclosure, a gas turbine engine comprises a first structure and a second structure rotating relative to the first structure, wherein one of the first structure and second structure comprises a substrate; and an abradable layer adhered to the substrate in a predefined net shaped structure, the abradable layer comprising at least one of a metal matrix discontinuously filled with hexagonal boron nitride and a MAX phase material.

In another and alternative embodiment, the substrate is an outer case, and the other rotating structure is a blade tip, wherein the blade tip is arranged adjacent the outer case without any intervening, separable seal structure. In another and alternative embodiment, a bond coating layer is adhered to the substrate and the abradable layer is adhered to the bond coating layer.

Further in accordance with the present disclosure, there is provided a method of manufacturing a gas turbine engine air seal comprises using an energy beam to build up sequential deposits of an agglomerated abradable feedstock material to form an abradable coating. The method includes controlling at least one of a structure and a composition of the air seal based on a pre-determined net shape model.

In another and alternative embodiment, the abradable feedstock material comprises a matrix alloy selected from the group consisting of Al, Cu, Ni, Co, Fe, Cr, Si, Y and a filler comprising at least one of hBN, MAX phases and bentonite.

In another and alternative embodiment, the abradable seal further comprises metal clad hBN particles with at least one of additional metal matrix particles, fugitive pore formers, glass micro-balloons, ceramic micro-balloons and additional soft phase material in a composite powder.

In another alternative embodiment, the method further comprises adjusting properties of the abradable coating during manufacture to target the properties required for a predetermined gas turbine engine section environment.

In another alternative embodiment, the method includes adjusting a ratio of the clad hBN particles to at least one of the additional metal matrix particles, the fugitive pore formers, and the additional soft phase material in a composite powder.

In another alternative embodiment, the pore formers comprise at least one of a carbon particle, a graphite particle and an oxide based micro-balloon. The pore formers can also comprise glass micro-balloon or ceramic micro-balloon. The carbon and graphite particles can be burned out at 900 degrees Fahrenheit to create the pores and prevent galvanic corrosion due to electrochemical cell formation between filers and the matrix.

In another alternative embodiment, the additional soft phase material comprises a bentonite agglomerated hBN.

In another alternative embodiment, the abradable feedstock material comprises MAX phase particles coated with a metallic shell.

In another alternative embodiment, the method further comprises forming random structures of the abradable feedstock material throughout the sequential deposits.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a perspective view of a portion of a gas turbine engine incorporating an air seal.

FIG. 2 shows a schematic view of an air seal.

FIG. 3 shows an exemplary abradable coating material.

FIG. 4 shows a cross sectional view of a coating on a substrate.

FIG. 5 shows an exemplary abradable coating material.

FIG. 6 shows a cross sectional view of a coating on a substrate.

Like reference numbers and designations in the various drawings indicate like elements.

### DETAILED DESCRIPTION

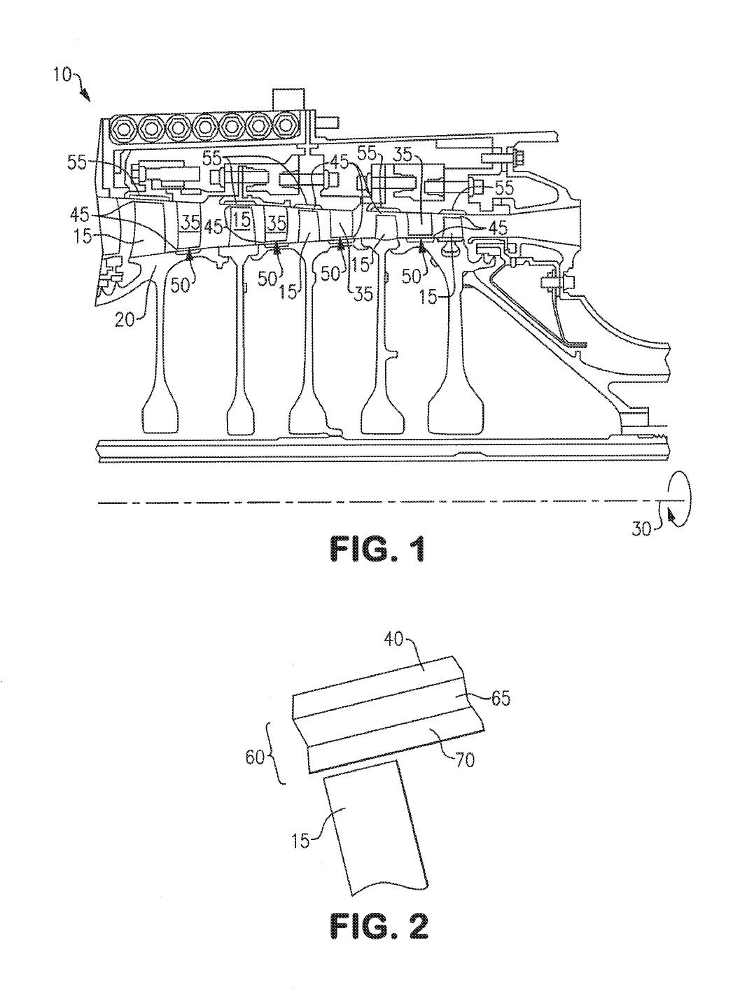

FIG. 1 shows a portion of a gas turbine engine 10, for example, a high pressure compressor section. The engine 10 has blades 15 that are attached to a hub 20 that rotate about an axis 30. Stationary vanes 35 extend from an outer case or housing 40, which may be constructed from a nickel alloy, and are axially interspersed between stages of the turbine blades 15, which may be constructed from titanium in one example. A first gap 45 exists between the blades 15 and the outer case 40, and a second gap 50 exists between the vanes 35 and the hub 20.

Air seals 60 (FIG. 2) are positioned in at least one of the first and second gaps 45, 50. Further, the air seals 60 may be positioned on: (a) the outer edge of the blades 15; (b) the inner edge of the vanes 35; (c) an outer surface of the hub 30 opposite the vanes 35; and/or (d) as shown in FIG. 2, on the inner surface of outer case 40 opposite the blades 15. It is desirable that the gaps 45, 50 be minimized and interaction between the blades 15, vanes 35 and seals 60 occur to minimize air flow around blade tips or vane tips.

In one example shown in FIG. 2, the air seal is integral with and supported by a substrate, in the example, the outer case 40. That is, the air seal 60 is deposited directly onto the outer case 40 without any intervening, separately supported seal structure, such as a typical blade outer air seal. The tip of the blade 5 is arranged in close, proximity to the air seal 60. It should be recognized that the seal provided herein may be used in any of a compressor, a fan or a turbine section and that the seal may be provided on rotating or non-rotating structure. The seal can also be for a turbine pump in a gas pipeline, a water or oil seal in a pump or other application.

The air seal 60 can include a bond coat 65 deposited onto the outer case 40. The bond coat 65 may comprise an alloy, such as a MCrAlY composition. In another exemplary embodiment, the bond coat 65 can be optional, if it is used, the bond coat 65 can be a nickel aluminum composite powder. A composite topcoat 70 acts as an abradable layer that is deposited on the bond coat 65 opposite the outer case 40. In an exemplary embodiment, the metallic bond coat 65 may be replaced by an adhesive layer if the abradable layer is pre-formed.

The exemplary abradable seal 60 can be employed in a variety of applications, such as, for bearing compartments, under-platform seals, cantilevered vane seals, rotating airfoil/blade seals, as well as air and oil seals.

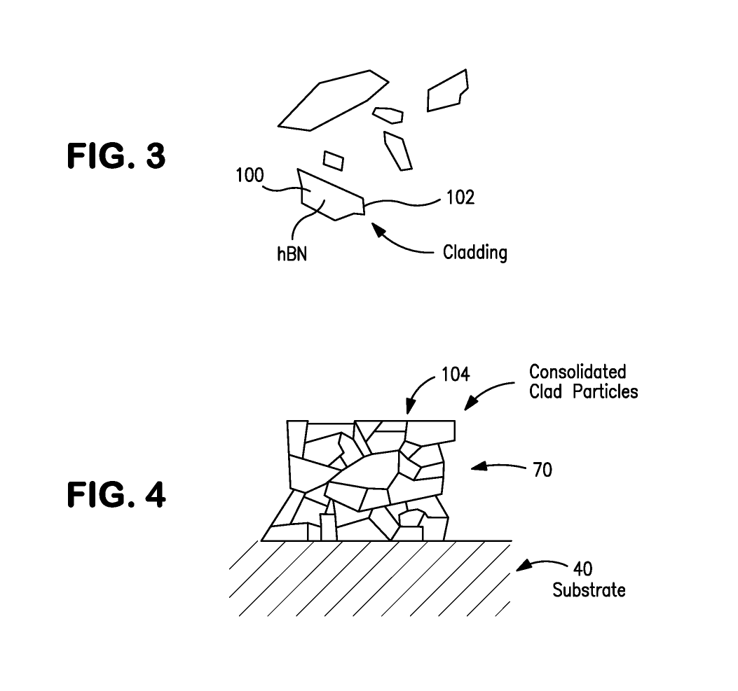

Referring also to FIGS. 3, 4, 5 and 6, the coating 70 can comprise a matrix alloy based on Al, Cu, Ni, Co, Fe, Cr, Si, Y and the like. In addition, the coating can include filler phases comprising hBN, MAX phases, bentonite, and the like.

In an alternative embodiment at FIGS. 3 and 4, the composite abradable coating 70 consists of a material that is a single distribution of a hexagonal boron nitride (“hBN”) 100 or soft ceramic material or other soft phase clad with a metallic-based alloy cladding 102 (such as a Ni based alloy, though others such as cobalt, copper, iron and aluminum are also contemplated herein). Feedstock used to provide the air seal 60 abradable coating 70 is made of composite powder particles of Ni alloy and hBN in which the metal is plated onto the hBN in a chemical cladding process, the metal clad hBN particles are used at a variable ratio with additional metal particles, fugitive pore formers, such as carbon or graphite particles or additional soft phase material (Such as bentonite agglomerated hBN) in the composite powder to adjust and target the coating properties during manufacture. In an exemplary embodiment, the additional metal particles may be the same composition as the plating or different. The additional particles can be alloying elements such as Al, Cr, Si, Y, B which may serve as a processing aid or modify the matrix alloy to provide some desired property such as oxidation resistance. It may be desirable to add Cr and/or Al and the like, as separate particles. The composition of these particles may advantageously combine with the matrix metal to improve oxidation resistance or other property (by diffusion during heat treatment or in service). Other compounds (known as soft phase material) such as a relatively soft (3 or less or preferably less than 2 on the Mohs hardness scale) ceramic like bentonite clay (e.g., a Montmorillonite) may be substituted for the hBN.

The matrix 102 of Ni based alloy may be coated upon the hBN 100 before application. In an exemplary embodiment, the metal cladding may also be produced as discrete elemental layers in order to facilitate manufacturing as it is difficult to co-deposit multiple elements as an alloy in the cladding process.

The volume fraction of hBN in the composite coating 104 is about 50-80%. The target metal content of the coating may be around 50% by volume or less. In one example, a volume fraction of hBN in the range of 75-80% is used. The target metal fraction can be on the order of 10-36% by volume. Some porosity, 0.5 to 15 volume % is normal in coatings depending on the application process and material. A low volume fraction of fugitive may be desirable to further reduce density and rub forces without substantially affecting roughness and gas permeability (e.g., less than about 25 volume %).

An additional volume fraction may be porosity which can be inherent in the application process or intentionally induced by application parameter selection or the addition of a fugitive material. Example fugitive materials are carbon and graphite powders. The low volume fraction of metal in combination with the hBN limits the ductility of a surface layer that forms by mechanical alloying due to plastic deformation as it is rubbed by an airfoil tip (or other rotating element) which results in good abradability. Low volume fraction of metal and poor bonding with the hBN also produces a low modulus composite that is somewhat flexible and compliant to part deformation and thermal expansion contributions to stress. The low modulus keeps stresses low.

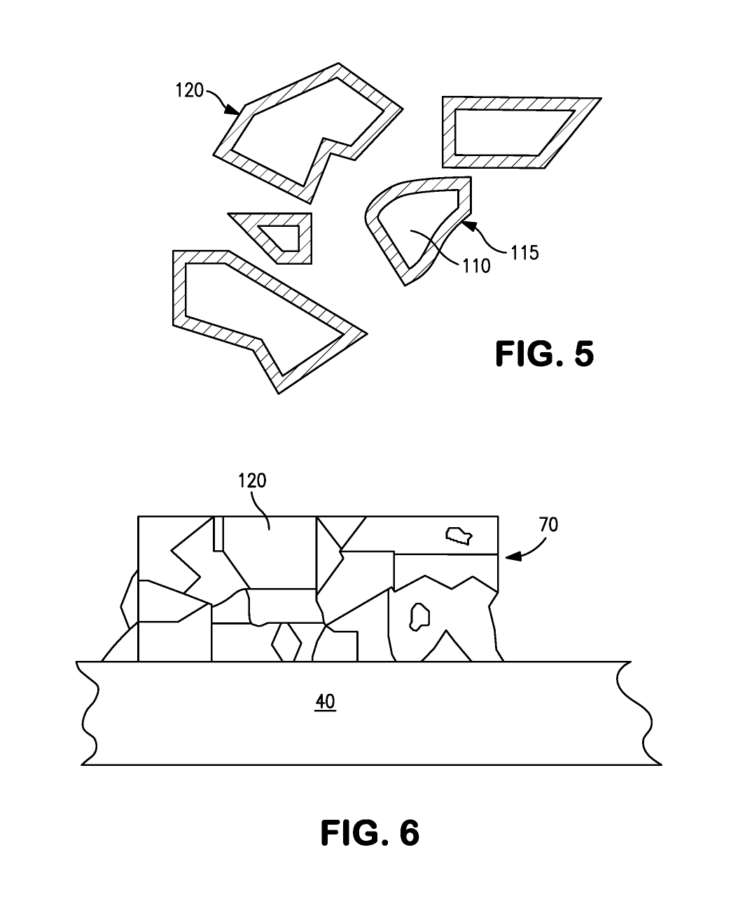

In another exemplary embodiment shown at FIGS. 5 and 6, the top coat 70 comprises a MAX phase solid. In an exemplary embodiment the coating includes MAX phase particles 110. The MAX phase particles 110 can include ternary carbide or nitride matrix material that may include MAX phases which are defined by the formula Mₙ₊₁AXₙ where n is a number from 1 to 3. M is an early transition metal element, A is an A group element, and X is carbon (C) or nitrogen (N). Early transition metals are any element in the d-block of the periodic table, which includes groups 3 to 12 on the periodic table. A-group elements are mostly group IIA or IVA. The metal matrix is at least one of a low, medium, and high melting point metal or metal alloy. Low melting point metals or metal alloys are those approximately in the range of from 100 degrees Centigrade to 300 degrees Centigrade. Medium melting point metals or metal alloys are those approximately in the range of 300 degrees Centigrade to 1000 degrees Centigrade. High melting point metals or metal alloys are those in the range of 1000 degrees Centigrade and greater. MAXMET materials are characterized by excellent mechanical properties and improved toughness, high damage tolerance, high thermal stability and improved erosion resistance.

The MAX phase particles 110 can be encapsulated in a metallic shell 115 to form a MAXMET composite material 120. The metallic shell 115 can comprise any variety of materials depending on the end use of the abradable composite seal 60. In an exemplary embodiment, the metallic shell 115 can comprise a Ni shell material for use with Ni-based abradable composite materials. In another exemplary embodiment the metallic shell 115 can comprise an Al shell for use with Al based abradable composite materials. Besides Ni and Al, depending on the applications, other metals, such as W, Co, Hf, Cr, and the like, can be applied as a coating layer. In an exemplary embodiment the matrix alloy cladding can be selected from the group Al, Cu, Ni, Co, Fe, Cr, Si and Y.

The air seal 60 can be deposited through a variety of methods into a net shape with very low material waste, for example <10% waste between feedstock and finished component. In an exemplary embodiment, the abradable layer could be produced by partial melting and/or sintering a powder feedstock with a laser beam or other form of concentrated energy to build up sequential fused deposits of the material. In an exemplary embodiment, fused and sintered can be considered interchangeable which include melting of <33% of the metallic component of the powder. In exemplary embodiments, some of the constituents of the powder feedstock material are not melted during the sintering. The concentrated energy can be used to cause low level bonding, while avoiding a complete melt down of the powder feedstock. Feedstock material can vary depending on the desired end product. Materials can be metal based powders including single constituent particles, chemically clad, mechanically clad and adhesively clad agglomerates. In exemplary embodiments, a powder can be considered to be metal based if it only has 25v % metal. For example, a thin layer of metal on a filler particle can be considered metal. Alternative concentrated energy can also include energy beams, such as, electron beams or electric arcs. The application process can include forming three-dimensional structures defined by CAD solid models using layer-by-layer deposition.

The net shaped structure of the seal 60 can be defined by a computer generated model, and this information is then sliced into a large number of deposition layers (e.g. tens to thousands of layers). In an exemplary embodiment, thin coatings could be made with only a handful of layers. A laser is then guided by each layer of information, over a powder layer to sinter and/or partially melt together the metal or metal clad particles. A layer of fresh powder is then swept over the previous layer and sintered and/or partially melted in a second laser pass to deposit the next layer. The process is repeated for the subsequent layers. Conveniently, the metal powder may alternatively be fed as a stream of powder directly into the laser beam at the point of deposition, and then rastered with the laser.

One or more embodiments have been described. Nevertheless, it will be understood that various modifications may be made. The layer-by-layer deposition procedure provides great control over the structure of the layer. It also allows seals to be formed with enhanced uniformity and repeatability, and with low incidence of manufacturing defects. The process reduces the need to make additional finishing steps, since the initial manufacturing steps produce a near net shaped product. Feedstock wastage may be 10% or less, compared with about 80% typical for thermal spraying.

The near net shape deposition eliminates the need for masking and much of the post machining processes.

Using an energy beam to build up sequential deposits of the fused feedstock allows precise control of the structure of the seal. Product variability can be reduced. Also the structure of the seal can be tailored throughout the seal's thickness to meet the attributes required for the intended operational environment.

In one embodiment, the coating provides a strong continuous network of metal matrix that is discontinuously filled with soft phase like hBN or hBN agglomerates. This is accomplished in an efficient manner by metal cladding hBN or hBN agglomerates and depositing them by net shaped laser sintering, also known in the art as direct metal laser sintering. The sintering method allows for the metal clad hBN to be bonded together without melting the hBN, that is, in the absence of melting the hBN material. In exemplary embodiments, it is contemplated that the interconnected metal matrix material can be further sintered post deposition to enhance bonding via post deposition heat treatment. In an exemplary embodiment, the post deposition sintering can be, for example, at 1925 F for 2 hours in vacuum. The sintering temperature will depend on the specific alloy utilized. The metal cladding results in a distributed soft phase that is surrounded by an interconnected metal matrix. The interconnectivity of the matrix provides high strength and toughness despite the relatively low volume fraction of metal. Target metal fraction is on the order of 10-36 V %. The low volume fraction of metal in combination with the hBN limits ductility of the smeared (mechanically alloyed) layer sometimes formed during abradable rub interaction resulting in good abradability.

The present coating structure and composition results in improved toughness, erosion resistance for a given metal content while maintaining abradability. The composition and structure provides low roughness and low gas permeability due to near fully dense coating structure. Roughness can be reduced due to the well distributed phases and low porosity compared with conventional coating composite structures.

The improved process reduces raw material cost and eliminates manufacturing operations for reduced part cost and lead time. It is estimated that feedstock powder usage can be reduced ˜5× and part lead time decreased by a week. The abradable coating will have low gas permeability, reduced density, favorable erosion resistance and a smooth surface finish. Accordingly, other embodiments are within the scope of the following claims.

What is claimed is:

1. A method of manufacturing a net shaped seal comprising:
depositing a first layer of powder material on a substrate; said powder material comprising an abradable feedstock material comprising matrix alloy clad filler particles, wherein said matrix alloy cladding is selected from the group consisting of Al, Cu, Ni, Co, Fe, Cr, Si and Y;
guiding a heat source over said powder material layer;
laser sintering said powder material, wherein at least one of:
said matrix alloy clad filler particles sinter, and
in the absence of said filler particles melting;
depositing a second layer of powder material over said first layer;
laser sintering said second layer of powder material with a second laser pass at predetermined locations; wherein at least one of:
said matrix alloy clad filler particles sinter, and
in the absence of said filler particles melting; and
repeating the depositing step and laser sintering step to form subsequent layers to form an abradable seal on said substrate.

2. The method of claim 1, further comprising:
applying a bond coat to said substrate prior to applying said first layer.

3. The method of claim 1, wherein the abradable seal is discontinuously filled with at least one of a hexagonal boron nitride, MAX phase material and a hexagonal boron nitride agglomerate.

4. The method of claim 1, wherein said abradable seal comprises additional metal matrix particles.

5. The method of claim 1, wherein said abradable seal is discontinuously filled with at least one of pore formers, glass micro-balloons, ceramic micro-balloons and a soft phase material.

6. The method of claim 1 wherein said feedstock is a composite powder comprising at least one of additional metal matrix particles, pore formers, glass micro-balloons, ceramic micro-balloons and a soft phase material.

7. The method of claim 1, wherein the abradable feedstock material comprises a MAX phase filler material.

8. The method of claim 1, further comprising:
cladding said matrix alloy onto said filler particles, by at least one of chemically cladding, mechanically cladding and adhesively cladding.

9. A gas turbine engine comprising:
a first structure;
a second structure rotating relative to the first structure, wherein one of the first structure and second structure comprises a substrate; and
an abradable layer adhered to the substrate in a predefined net shaped structure, the abradable layer comprising at least one of a metal matrix discontinuously filled with hexagonal boron nitride and a MAX phase material.

10. The gas turbine engine of claim 8, wherein the substrate is an outer case, and the other rotating structure is a blade tip, wherein the blade tip is arranged adjacent the outer case without any intervening, separable seal structure.

11. The gas turbine engine of claim 8, further comprising:
a bond coating layer adhered to the substrate; and
said abradable layer adhered to said bond coating layer.

12. A method of manufacturing a gas turbine engine air seal comprising:
using an energy beam to build up sequential deposits of a abradable feedstock material to form an abradable coating wherein the abradable feedstock material comprises a matrix alloy selected from the group consisting of Al, Cu, Ni, Co, Cr, Fe, Si, Y and a metal clad filler comprising at least one of hBN, MAX phases and bentonite; and
controlling at least one of a structure and a composition of the air seal based on pre-determined processing parameters and composition.

13. The method of manufacturing a gas turbine engine air seal of claim 12, wherein said abradable coating further comprises metal clad hBN particles with at least one of additional metal matrix particles, pore formers, glass micro-balloons, ceramic micro-balloons and additional soft phase material.

14. The method of manufacturing a gas turbine engine air seal of claim 12 further comprising:
adjusting properties of said abradable coating during manufacture to target the properties required for a predetermined gas turbine engine section environment; wherein adjusting further comprises adjusting a ratio of said clad hBN particles to at least one of said additional metal matrix particles, said fugitive pore formers, and said additional soft phase material in a composite powder.

15. The method of manufacturing a gas turbine engine air seal of claim 14 wherein said fugitive pore formers comprise at least one of a carbon particle, a graphite particle and an oxide based micro-balloon.

16. The method of manufacturing a gas turbine engine air seal of claim 14 wherein said additional soft phase material comprises a bentonite agglomerated hBN.

17. The method of manufacturing a gas turbine engine air seal of claim 12, wherein the abradable feedstock material comprises MAX phase particles coated with a metallic shell.

18. The method of manufacturing a gas turbine engine air seal of claim 14, further comprising post deposition heat treatment.

19. The method of manufacturing a gas turbine engine air seal of claim 12, further comprising:
forming random structures of said abradable feedstock material throughout said sequential deposits.
